(19) United States
(12) Patent Application Publication
(10) Pub. No.: US 2005/0015790 A1
(43) Pub. Date: Jan. 20, 2005

(54) Optical pickup and manufacturing method thereof

(75) Inventor: Akiho Yoshizawa, Higashihiroshima-Shi (JP)

Correspondence Address: MORRISON & FOERSTER LLP, 755 PAGE MILL RD, PALO ALTO, CA, 94304-1018, US

(73) Assignee: SHARP KABUSHIKI KAISHA, Osaka-shi (JP)

(21) Appl. No.: 10/893,739

(22) Filed: Jul. 16, 2004

(30) Foreign Application Priority Data
Jul. 18, 2003 (JP) 199416/2003

(51) Int. Cl. G11B 7/08

(52) U.S. Cl. 720/658

(57) ABSTRACT

An optical pickup in which an actuator base is fixed to an actuator base fixing section of a housing is arranged so that a rigid body ball is provided in a gap between a side face of the actuator base fixing section and the actuator base, the rigid body ball pressing both the side face of the actuator base fixing section and the actuator base. With this, it is possible to prevent the relative positions of the actuator base and the actuator base fixing section from being misaligned.

This Nonprovisional application claims priority under 35 U.S.C. § 119(a) on Patent Application No. 199416/2003 filed in Japan on Jul. 18, 2003, the entire contents of which are hereby incorporated by reference.

### FIELD OF THE INVENTION

The present invention relates to an optical pickup suitably applied to an optical disk drive device which optically records and reproduces information to and from an information recording medium such as an optical disk, for example; and a manufacturing method thereof. More specifically, the present invention relates to an optical pickup in which a part such as an actuator and a raising mirror is positioned, glued, and fixed with respect to a case (housing); and a manufacturing method thereof.

### BACKGROUND OF THE INVENTION

In many areas such as audio equipment, video equipment, and computers, optical disks are used as information recording mediums capable of recording a large quantity of information signals in high density. In order to reproduce information signals that are recorded per unit of μm on an information recording medium such as the optical disk, it is necessary to cause light to precisely track the tracks of the optical disk.

Here, if the position/angle of a part such as an objective lens and a total reflection mirror is misaligned in an optical system, coma aberration and astigmatism may occur and prevent proper recording and reproducing.

DVDs, in particular, have higher signal recording density compared with, for example, CDs. For this reason, in order to record and reproduce information to and from an information recording medium such as a DVD, an DVD-writable optical pickup needs to be arranged so that parts of the optical system such as the objective lens and the raising mirror are positioned with high precision.

FIG. 7 is a top view schematically showing an arrangement of chief members of actuator base fixing sections and raising mirror fixing sections in a conventional optical pickup. FIG. 8 is a cross-sectional view taken on lines D-D′ of FIG. 7. FIG. 8 schematically shows arrangements of an actuator fixed to the actuator base fixing sections, and an objective lens holder fixed to the actuator.

Further, FIG. 9 is a cross-sectional view taken on lines E-E′ of FIG. 7. FIG. 9 schematically shows arrangements of a raising mirror fixed to the raising mirror fixing sections.

As shown in FIGS. 7 and 8, an objective lens 30 is fixed to an objective lens holder 31, the objective lens holder 31 is fixed to an actuator base 32, and the actuator base 32 is fixed to actuator base fixing sections 35. Further, as shown in FIG. 9, a raising mirror 34 is fixed to mirror fixing sections 36. The actuator base fixing sections 35 and the mirror fixing sections 36 are formed as a part of a housing 33.

As shown in FIGS. 8 and 9, the actuator base 32 and the actuator base fixing sections 35, as well as the raising mirror 34 and the mirror fixing sections 36, are fixed to each other using only adhesive agent 40.

As shown in FIG. 8, the actuator fixing sections 35 are formed as a part of the housing 33. The actuator base fixing sections 35 and the actuator base 32 are connected (glued) to each other via the adhesive agent 40.

Specifically, the actuator base 32 is fixed to the actuator base fixing sections 35 in such a method that, while the actuator base 32 is inserted between the actuator base fixing sections 35, the adhesive agent 40 is infused into grooves 35a provided to the actuator base fixing sections 35.

Further, as shown in FIG. 9, the mirror fixing sections 36 are formed as a part of the housing 33. The mirror fixing sections 36 and the raising mirror 34 are connected to each other via the adhesive agent 40. Specifically, the raising mirror 34 is fixed to the raising mirror fixing sections 36 in such a method that, while the raising mirror 34 is inserted between the raising mirror fixing sections 36, the adhesive agent 40 is infused into grooves 36a provided to the raising mirror fixing sections 36.

As described above, the actuator base fixing sections 35 and the actuator base 32, as well as the mirror fixing sections 36 and the raising mirror 34, all of which are provided to the housing 33, are fixed to each other using only the adhesive agent 40 that is provided in the grooves 35a and 36a.

Further, Patent Document 1 (Japanese Unexamined Patent Publication No. 2002-56563; published on Feb. 22, 2002), for example, discloses an arrangement for fixing a mirror to a mirror holder in the following manner. Namely, a U-shaped bent elastic member is inserted between the mirror and the mirror holder, and while the mirror is held utilizing the restitutive force of the elastic member, adhesive agent is infused between the mirror and the mirror holder. Further, in the arrangement of Patent Document 1, the mirror holder is fixed to the housing using only the adhesive agent.

However, if a part such as the mirror and the actuator base is fixed to the housing by use of adhesive agent infused into a gap between the part and the housing, the following problems occur.

Specifically, if the part is fixed to the housing using only adhesive agent, the adhesive agent expands or shrinks due to external force or changes in surrounding environment (such as temperature and humidity). If the adhesive agent shrinks or expands, the position of the part whose position is fixed by the adhesive agent changes in the housing. Therefore, if the part is fixed using only adhesive agent, it is difficult to fix the part to the housing without causing the position/angular misalignment of the part.

In particular, if the part is fixed to the housing using only adhesive agent, and there is a difference in width between two gaps respectively between two side faces of the part and side faces of the housing which respectively face the two side faces of the part, the position/angle of the part may be misaligned.

Further, if amounts of the adhesive agent respectively infused into the two gaps are different from each other, for example, time until the adhesive agent is cured and the shrinkage of the adhesive agent when cured are different from each other. This may cause the misalignment of the position/angle of the part.

Further, in an annealing step using a thermostatic chamber in the manufacturing process of an optical pickup, a problem occurs such that, due to the difference in curing time and shrinkage of the adhesive agent, the fixed position of the part after adjusted may be misaligned.

If the position/angle of the part fixed to the housing in the optical pickup is misaligned, the optical pickup becomes a defective product in some instances. This lowers the productivity of optical pickups.

Further, the arrangement of Patent Publication 1 uses the restitutive force of the U-shaped bent elastic member to press the mirror on the mirror fixing section. Accordingly, if external force (including the thermal expansion and thermal shrinkage of the adhesive agent) is put on the elastic member, for example, the elastic member is deformed in accordance to the external force.

Therefore if the adhesive agent that fixes around the elastic member expands (shrinks) due to heat, for example, the elastic member is also deformed in accordance with the expansion of the adhesive agent. With this, it is not possible to fix the mirror to the mirror fixing section in a predetermined position. In other words, with the arrangement of Patent Publication 1, the fixed position/angle of the mirror may be misaligned due to external force.

### SUMMARY OF THE INVENTION

In view of the foregoing problems, the present invention has an objective to provide an optical pickup capable of preventing the position/angular misalignment of the fixed part fixed to the housing, the position/angular misalignment being caused by external force and changes in surrounding environment.

In order to achieve the foregoing objects, an optical pickup of the present invention is arranged so as to include a case; a fixed part fixed to an inside of the case; and a rigid body provided between a side face of the case and a side face of the fixed part, the rigid body pressing both the side faces and retaining relative positions of the case and the fixed part.

With this arrangement, the case and the fixed part contact each other via the rigid body, and the rigid body presses both the case and the fixed part. Namely, the rigid body presses the case and the fixed part so as to retain a constant distance between the case and the fixed part.

With this, compared with the conventional arrangement in which the case and the fixed part are glued to each other using only adhesive agent, it is possible to prevent the misalignment of the position/angle in which the fixed part is fixed to the case (relative positions between the case and the fixed part) even if the optical pickup is subject to external force, for example. Accordingly, it is possible to fix the fixed part without causing position/angular misalignment, compared with the conventional arrangement. This can prevent the misalignment of the position/angle of the fixed part after the optical pickup is assembled and subject to position alignment such as the alignment of the optical axes, for example. Namely, with this arrangement, it is possible to improve the product reliability of the optical pickup.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a plan view schematically showing an arrangement of chief members, including actuator base fixing sections 2 of a housing 1, provided to an optical pickup in accordance with an embodiment of the present invention.

FIG. 2 is a cross-sectional view taken on lines A-A′ of FIG. 1.

FIG. 3 is a plan view schematically showing an arrangement of the optical pickup in accordance with the present embodiment.

FIG. 4 is a cross-sectional view of the optical pickup.

FIG. 5 is a plan view schematically showing an arrangement of chief members, including raising mirror fixing sections 3 of the housing 1, provided to an optical pickup in accordance with another embodiment of the present invention.

FIG. 6 is a cross-sectional view taken on lines C-C′ of FIG. 5.

FIG. 7 is a plan view schematically showing an arrangement of chief members of actuator base fixing sections and raising mirror fixing sections in a conventional optical pickup.

FIG. 8 is a cross-sectional view taken on lines D-D′ of FIG. 7.

FIG. 9 is a cross-sectional view taken on lines E-E′ of FIG. 7.

### DESCRIPTION OF THE EMBODIMENTS

[First Embodiment]

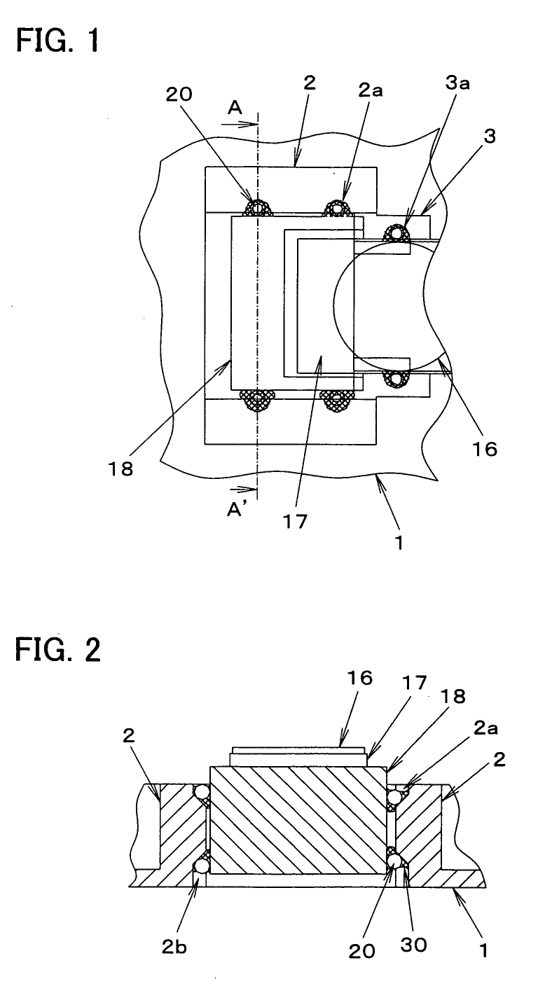

The following will explain an embodiment of an optical pickup of the present invention with reference to FIGS. 1 through 4.

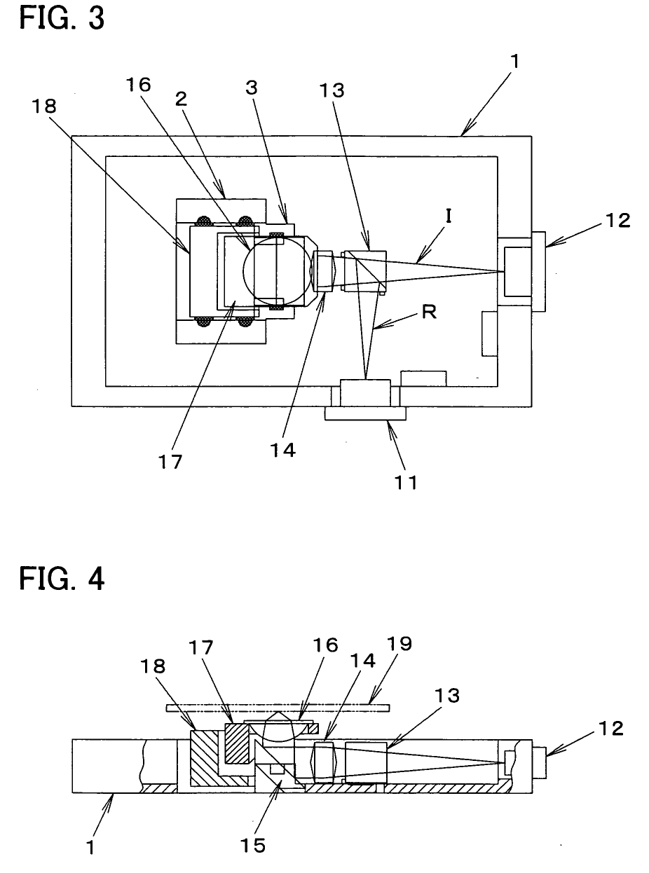

FIG. 3 is a top view schematically showing an arrangement of an optical pickup in accordance with the present embodiment. Further, FIG. 4 is a cross-sectional view of the optical pickup. As shown in FIGS. 3 and 4, the optical pickup in accordance with the present embodiment is composed of a light source A11, a light source B12, a beam splitter 13, a collimating lens 14, a raising mirror (fixed part) 15, an objective lens 16, an objective lens holder 17, an actuator base 18 (fixed part), and a housing 1.

The housing 1 is provided with actuator base fixing sections (case) 2 which fix the actuator base 18, and raising mirror fixing sections (case) 3 which fix the raising mirror 15. The objective lens 16 is fixed to the objective lens holder 17. The objective lens holder 17 is fixed to the actuator base 18.

Further, the actuator base fixing sections 2 fix the actuator base 18 using rigid body balls 20 to be described later such that inside side faces of the actuator base fixing sections 2 respectively face side faces of the actuator base 18.

The objective lens 16 collects on a surface of an optical disk 19, light R and light I respectively exited from the light source A11 and the light source B12. The collimating lens 14 converts the light exited from the light sources A11 and B12 into parallel light. The beam splitter 13 is coated with a polarizing film (polarizing filter) which, in accordance with a polarizing direction of the polarizing film, either transmits or reflects light. Here, the polarizing direction is set so as to reflect the light R from the light source A11 and transmit the light I from the light source B12.

Here, a method for using the optical pickup to read information that is recorded on the optical disk 19 will be explained. First, the light exited from the light sources A11 and B12 is converted into parallel light by the collimating lens 14, reflected by the raising mirror 15, and collected by the objective lens 16 on the surface of the optical disk 19. Then, the light reflected by the optical disk 19 sequentially passes through the objective lens 16, the raising mirror 15, and the collimating lens 14, and enters a light-receiving element (not shown) where the reflected light is to be detected.

Here, the objective lens 16, the raising mirror 15, the collimating lens 14, and the like are respectively fixed to their corresponding fixing sections (the objective lens holder 17, the raising mirror fixing sections 3, and a collimating lens holder (not shown)), with the optical axes of the objective lens 16, the raising mirror 15, the collimating lens 14, and the like being adjusted. The following will explain arrangements of the fixing sections which fix the optical parts such as the raising mirror 15, for example.

FIG. 1 is a top view schematically showing an arrangement of chief members, including the actuator base fixing sections 2 of the housing 1, provided to the optical pickup in accordance with the present embodiment. Further, FIG. 2 is a cross-sectional view taken on lines A-A′ of FIG. 1.

As shown in FIG. 1, the housing 1 is provided with the actuator base fixing sections 2 that fix the actuator base 18 and the raising mirror fixing sections 3 that fix the raising mirror (not shown). The actuator base 18 is provided with the objective lens holder 17. The objective lens holder 17 is fixed to the actuator base 18. The objective lens holder 17 fixes the objective lens 16.

Namely, on the housing 1, the actuator base fixing sections 2 fix the actuator base 18, and the actuator base 18 fixes the objective lens holder 17.

With reference to FIG. 2, the following will explain an arrangement in which the actuator base 18 is fixed to the actuator base fixing sections 2.

As shown in FIG. 2, the actuator base 18 is fixed such that the side faces of the actuator base 18 respectively face the inside side faces of the actuator base fixing sections 2. Specifically, gaps are formed respectively between the side faces of the actuator base 18 and the side faces of the actuator base fixing sections 2, and rigid body balls 20 are respectively placed in the gaps so as to press both the actuator base 18 and the actuator base fixing section 2. In other words, the rigid body balls 20 engage with the gaps.

Around the rigid body ball 20 is fixed using the adhesive agent 30. Specifically, the adhesive agent 30 is used to glue the rigid body ball 20 to the actuator base fixing section 2 and to glue the rigid body ball 20 to the actuator base 18. In other words, in the present embodiment, it is not the adhesive agent 30 which fixes the actuator base fixing sections 2 and the actuator base 18 so as to retain the relative positions between the actuator base fixing sections 2 and the actuator base 18; but it is the rigid body balls 20 that retain the relative positions of the actuator base fixing sections 2 and the actuator base 18. Specifically, the adhesive agent 30 glues around contact points where the rigid body balls 20 contact (press) the actuator base fixing sections 2, and around contact points where the rigid body balls 20 contact (press) the actuator base 18.

Here, the contact points between the rigid body balls 20 and the actuator base fixing sections 2 will be explained in more detail.

As shown in FIG. 2, grooves (restricting section) 2a and 2b are formed in the side faces of the actuator base fixing sections 2 that respectively face the actuator base 18 when the actuator base 18 is fixed to the actuator base fixing sections 2 (hereinafter referred to as opposed side faces). Specifically, the grooves 2a and 2b are formed at end portions of the opposed side faces of the actuator base fixing sections 2. Further, the rigid body balls 20 are fit in the grooves 2a and 2b.

The groove 2a is provided to the end portion that is closer to a surface of the actuator base 18 on which the objective lens holder 17 holding the objective lens 16 is provided. In other words, the groove 2a is formed at the end portion that is farther from a surface of the housing 1 on which the actuator base 18 is placed. Further, the groove 2a is sloped such that a distance between a bottom face of the groove 2a and the side face of the actuator base 18 becomes narrower toward a depth direction (inserting direction) of the actuator base 18 that is inserted into the housing 1. On the other hand, the groove 2b is sloped such that a distance between a bottom face of the groove 2b and the side face of the actuator base 18 becomes narrower toward a direction opposite to the inserting direction of the actuator base 18 that is inserted into the housing 1. Further, the grooves 2a and 2b are sloped such that distances between the bottom faces of the groove 2a and 2b and the side face of the actuator base 18 respectively become narrower toward the middle of the opposed side face of the actuator base fixing section 2.

Further, the rigid body balls 20 are respectively fit in the grooves 2a and 2b, and the rigid body balls 20 respectively adhere to the grooves 2a and 2b using the adhesive agent 30 so as to respectively contact the grooves 2a and 2b. Specifically, the rigid body balls 20 are glued to the grooves 2a and 2b in such a method that the rigid body balls 20 are respectively fit in the grooves 2a and 2b (or the rigid body balls 20 are respectively placed in the grooves 2a and 2b) and then the adhesive agent 20 is infused into the grooves 2a and 2b.

Here, a method for using the rigid body balls 20 to fix the actuator base 18 to the actuator base fixing sections 2 will be explained. Note that, the following will explain an arrangement in which the groove 2a is provided to the opposed side face of the actuator base fixing section 2.

First, the position of the objective lens 16, namely, the position of the actuator base 18 with respect to the actuator base fixing sections 2 is adjusted. Specifically, the optical axes (positions) of the optical parts such as the objective lens 16 and the raising mirror 15 are adjusted, and, using a jig, the actuator base 18 is held in an adjusted position with respect to the housing 1. With this, it is possible to retain predetermined widths of the gaps respectively between the opposed side faces of the actuator base fixing sections 2 of the housing 1 and the side faces of the actuator base 18.

Next, the rigid body ball 20 is fit in the groove 2a formed in the opposed side face of the actuator base fixing section 2. Namely, the rigid body ball 20 is fit so as to engage with the gap formed between the actuator base 18 and the groove 2a. With this, the rigid body ball 20 presses the actuator base fixing section 2 and the actuator base 18. Then, the adhesive agent 30 is infused into the groove 2a.

As described above, the optical pickup in accordance with the present embodiment is arranged so that the actuator base 18 is fixed to the actuator base fixing sections 2 using the rigid body balls 20. Specifically, the optical pickup is arranged so that the rigid body ball 20 is fit in the gap between the actuator base 18 and the actuator base fixing section 2 so that the rigid body ball 20 is sandwiched between the actuator base 18 and the actuator base fixing section 2. With this, it is possible to prevent the misalignment of the relative positions of the actuator base 18 and the actuator base fixing sections 2 even if the optical pickup is subject to some external force, for example. Accordingly, it is possible to fix the actuator base 18 without causing position misalignment, compared with the conventional arrangement. This can prevent the misalignment of the position of the actuator base 18 after the optical pickup is assembled and subject to position alignment such as the alignment of the optical axes, for example. In other words, with the foregoing arrangement, it is possible to improve the reliability of the optical pickup.

Namely, the rigid body ball 20 contacts and presses at almost one point, each of the actuator base 18 and the actuator base fixing section 2. Therefore this arrangement is not affected by volume change of the adhesive agent due to thermal shrinkage and thermal expansion, compared with, for example, the conventional arrangement in which the actuator base 18 is fixed to the actuator base fixing sections 2 using only adhesive agent. Further, by gluing around the rigid body ball 20 with the adhesive agent 30, it is possible to prevent the misalignment of the position of the rigid body ball 20.

In some instances, as a result of the position adjustment of the objective lens 16, the actuator base 18 may be fixed such that the two gaps, which are respectively formed between the actuator base fixing sections 2 and the actuator base 18 and opposed to each other in the direction of lines A-A′ of FIG. 1, have different widths from each other. In such an instance, in particular, the position misalignment due to the shrinkage and expansion of the adhesive agent is liable to occur in the conventional arrangement in which the adhesive agent is used to fix the actuator base, because the amounts of the adhesive agent respectively used in the two gaps are different from each other. However, in the present embodiment, the rigid body ball 20 is used to fix the actuator base 18 to the actuator base fixing section 2, thereby preventing the position misalignment more surely.

Further, by forming the grooves 2a and 2b in the opposed side faces of the actuator base fixing sections 2, it is possible to restrict the movement of the rigid body ball 20 in a gap direction. The gap direction refers to a direction orthogonal to the depth direction, and an extending direction of the gap when seen from the rigid body ball 20. Further, by forming the grooves 2a and 2b, it is possible to pre-determine the positions in which the rigid body balls 20 are to be fit. Further, by providing slopes to the grooves 2a and 2b, it is possible to cause the rigid body balls 20 to surely engage with the gaps between the actuator base fixing sections 2 and the actuator base 18.

Note that, in an instance as shown in FIG. 2 where the gaps 2a and 2b are respectively provided to both upper and lower portions (end portions) of the opposed side face of the actuator base fixing section 2, the rigid body balls 20 may be respectively fit in the grooves 2a and 2b and fixed as follows. Namely, the rigid body ball 20 is fit in either one of the groove at the upper portion and the groove at the lower portion, and fixed using the adhesive agent 30; and then the other portion is similarly fixed after the actuator base fixing section 2 is reversed. By fixing both the upper and lower portions of the actuator base 18 using the rigid body balls 20 as described above, it is possible to fix the actuator base 18 more securely, thereby further preventing the position/angular misalignment of the actuator base 18. Note that, the lower portion refers to the end portion of the opposed side face that is closer to the housing 1, and the upper portion refers to the end portion of the opposed side face that is farther from the housing 1.

Further, it is preferable that the rigid body balls 20 are made of the same material that makes up the actuator base fixing sections 2 of the housing 1. With this, the rigid body balls 20 and the actuator base fixing sections 2 thermally expand at the same rate even if the ambient temperature changes. Therefore the contact points between the rigid body balls 20 and the actuator base fixing sections 2 of the housing 1 are not misaligned due to the thermal expansion and shrinkage. This further reduces the position misalignment of the actuator base 18.

Here, the rigid body balls 20 will be explained. It is more preferable that the rigid body balls 20 are made of a material that is not much affected by thermal expansion and shrinkage. Further, in the above-mentioned instance where the rigid body balls 20 are fit in between the actuator base fixing sections 2 and the actuator base 18, it is more preferable that the rigid body balls 20 are made of the same material as the material of the actuator base fixing sections 2 and/or the actuator base 18. Specifically, the material of the rigid body balls 20 may be zinc ball, and aluminum ball, for example. One type of the exemplified material, or two or more types of the exemplified material in combination may be used.

Further, though the size of the rigid body ball 20 should vary depending on the size of the actuator base fixing sections 2 and the actuator base 18, it is more preferable that the diameter of the rigid body ball 20 is in a range of from 0.5 mm to 1.5 mm in view of the assembling process.

Further, the grooves 2a and 2b restrict the movement of the rigid body balls 20 in the gap direction, but the restricting section is not limited to the grooves. Namely, the restricting section is only required to restrict the movement of the rigid body balls 20 in the gap direction, and may be, for example, two protrusions protruded from the opposed side face of the actuator base fixing section 2, a concave portion provided in the opposed side face, and the like. Namely, if the rigid body ball 20 is fit in between the two protrusions, the protrusions restrict the movement of the rigid body ball 20 in the gap direction.

Further, if the grooves 2a and 2b are formed in the actuator base fixing section 2, it is more preferable that the grooves 2a and 2b have V-shaped cross-sections. With the V-shaped cross-sections of the grooves 2a and 2b, the rigid body ball 20 is fixed to the grooves 2a and 2b, respectively at two points. Therefore the rigid body balls 20 can more surely fix the actuator base fixing sections 2 to the actuator base 18 without position misalignment, and can restrict the movement of the rigid body balls 20 in the gap direction well. Note that, the shape of the cross-section of the groove refers to the shape of a cross-section of the groove taken along a surface orthogonal to an extending direction of the groove.

Note that, the foregoing explained the arrangement in which the grooves 2a and 2b are formed only in the actuator base fixing sections 2, but a groove may be formed in the actuator base 18, for example. Specifically, it is more preferable that the groove is formed in either one of the side face of the actuator base fixing section 2 and the side face of the actuator base 18, and the grooves may be respectively formed in both the side faces.

Further, the shape of the grooves 2a and 2b is not limited to the above-mentioned shape, and may be any shape that allows the rigid body ball 20 to contact both the actuator base fixing section 2 and the actuator base 18 when the rigid body ball 20 is fit in between the actuator base fixing section 2 and the actuator base 18. Further, the number and position of the rigid body balls 20 are not limited to the foregoing arrangement.

Further, the present embodiment described the instance where the rigid body ball 20 is used as rigid body, but the shape of the rigid body is not limited to this. The material, size, shape, etc., of the rigid body is not limited, provided that the rigid body can press both the fixed part and the case when fit in between the case and the fixed part.

Note that, the foregoing explained the instance where the actuator base fixing sections 2 are used as the case and the actuator base 18 is used as the fixed part, but the case and the fixed part are not limited to these. An arrangement which uses the raising mirror fixing section 3 as the case and the raising mirror 15 as the fixed part will be explained later.

Note that, the explanation of the present embodiment used the base fixing sections 2 as the case and the actuator base 18 as the fixed part, but the case and the fixed part are not limited to these. Further, whether a part is either the case or the fixed part cannot be uniquely determined.

Namely, the actuator base 18 corresponds to the fixed part with respect to the actuator base fixing sections 2, and the actuator base 18 corresponds to the case with respect to the objective lens holder 17. Further, the objective lens holder 17 corresponds to the case with respect to the objective lens 16.

[Second Embodiment]

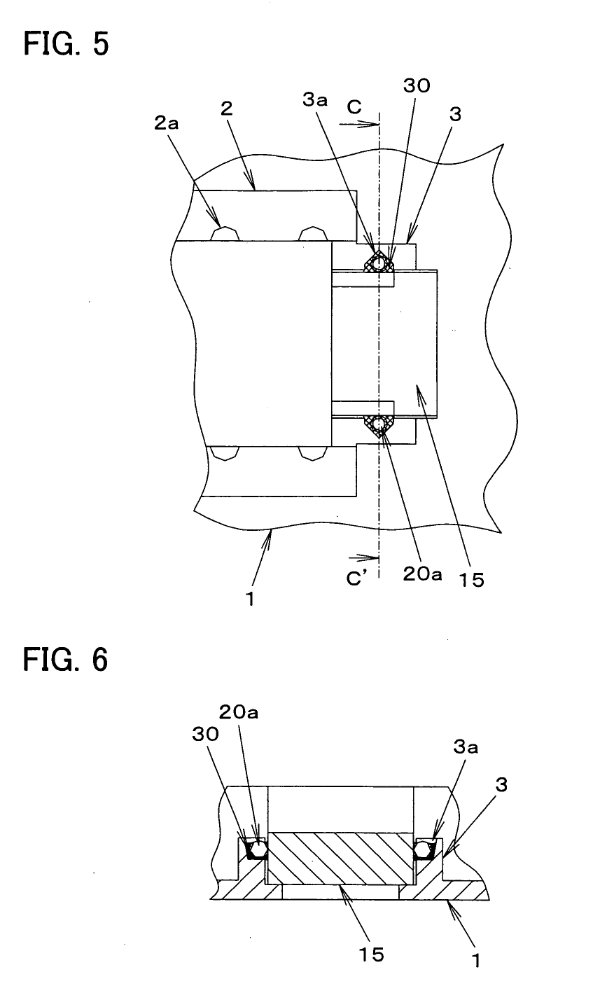

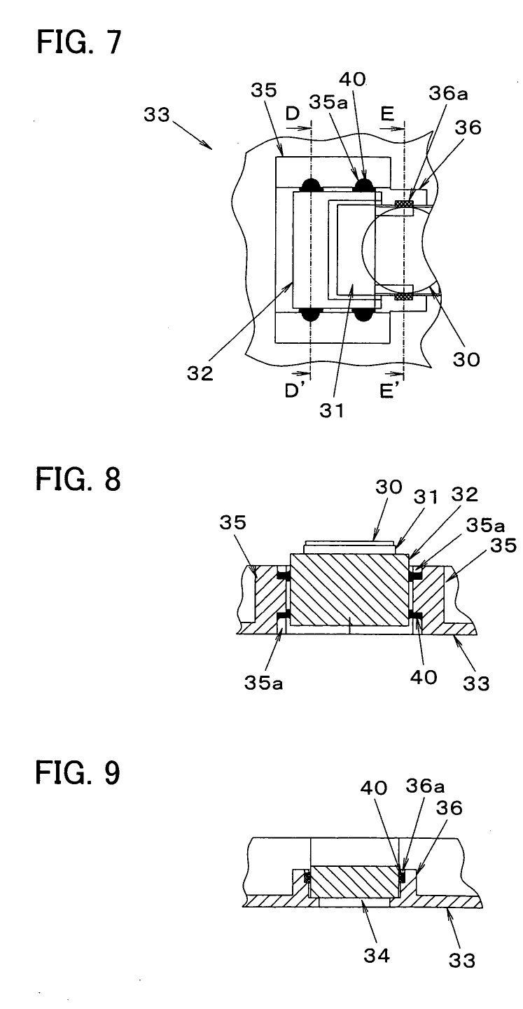

The following will explain another embodiment of the present invention with reference to FIGS. 5 and 6. For ease of explanation, members having the same functions as those used in First Embodiment will be given the same symbols, thus their explanation is omitted here.

FIG. 5 is a plan view schematically showing an arrangement of chief members, including the raising mirror fixing sections 3 of the housing 1, provided to an optical pickup in accordance with the present embodiment. FIG. 6 is a cross-sectional view taken on lines C-C′ of FIG. 5. With reference to FIGS. 5 and 6, another arrangement of fixing sections of the housing 1 in the optical pickup in accordance with the present embodiment will be explained.

As shown in FIG. 5, the housing 1 is provided with the raising mirror fixing sections (case) 3 which fix the raising mirror (fixed part) 15. In other words, the raising mirror 15 is fixed to the raising mirror fixing sections 3.

With reference to FIG. 6, the following will explain an arrangement in which the raising mirror 15 is fixed to the raising mirror fixing sections 3.

As shown in FIG. 6, the raising mirror 15 is fixed such that the side faces of the raising mirror 15 respectively face the inside side faces of the raising mirror fixing sections 3. Specifically, gaps are formed respectively between the side faces of the raising mirror 15 and the side faces of the raising mirror fixing sections 3, and rigid body balls 20a are respectively placed in the gaps so as to press both the raising mirror 15 and the raising mirror fixing section 3. Around the rigid body ball 20a is fixed using the adhesive agent 30. Specifically, the adhesive agent 30 is used to glue the rigid body ball 20a to the raising mirror fixing section 3 and to glue the rigid body ball 20a to the raising mirror 15. In other words, in the present embodiment, it is not the adhesive agent 30 which fixes the raising mirror fixing sections 3 and the raising mirror 15 so as to retain the relative positions between the raising mirror fixing sections 3 and the raising mirror 15; but it is the rigid body balls 20a that retain the relative positions of the raising mirror fixing sections 3 and the raising mirror 15. Specifically, the adhesive agent 30 glues around contact points where the rigid body balls 20a contact (press) the raising mirror fixing sections 3, and around contact points where the rigid body balls 20a contact (press) the raising mirror 15.

Here, the contact points between the rigid body balls 20a and the raising mirror fixing sections 3 will be explained in more detail.

As shown in FIG. 6, grooves (restricting section) 3a are formed in the side faces of the raising mirror fixing sections 3 that respectively face the raising mirror 15 when the raising mirror 15 is fixed to the raising mirror fixing sections 3. Specifically, the grooves 3a are formed at end portions of the opposed side faces of the raising mirror fixing sections 3 that are farther from the surface on which the raising mirror 15 is placed. Further, the rigid body balls 20 are respectively fit in the grooves 3a.

Further, the groove 3a is sloped such that a distance between a bottom face of the groove 3a and the side face of the raising mirror 15 becomes narrower toward the middle of the opposed side face of the raising mirror fixing section 3 (middle of the opposed area).

Further, the rigid body balls 20a are respectively fit in the grooves 3a, and the rigid body balls 20a respectively adhere to the grooves 3a using the adhesive agent 30 so as to respectively contact the grooves 3a. Specifically, the rigid body balls 20 are glued to the grooves 3a in such a method that the rigid body balls 20 are respectively fit in the grooves 3a and then the adhesive agent 30 is infused into the grooves 3a.

Here, a method for using the rigid body balls 20a to fix the raising mirror 15 to the raising mirror fixing sections 3 will be explained. Note that, the following will explain an arrangement in which the groove 3a is provided to the opposed side face of the raising mirror fixing section 3.

First, the position of the objective lens 16, namely, the position of the raising mirror 15 with respect to the raising mirror fixing sections 3 is adjusted. Specifically, the optical axes (positions) of the optical parts such as the objective lens 16 and the raising mirror 15 are adjusted, and, using a jig, the raising mirror 15 is held in an adjusted position with respect to the housing 1 (raising mirror fixing sections 3). With this, it is possible to retain predetermined widths of the gaps respectively between the opposed side faces of the raising mirror fixing sections 3 of the housing 1 and the side faces of the raising mirror 15.

Next, the rigid body ball 20a is fit in the groove 3a formed in the opposed side face of the raising mirror fixing section 3. Namely, the rigid body ball 20a is fit so as to engage with the gap formed between the raising mirror 15 and the groove 3a. With this, the rigid body ball 20a presses the raising mirror fixing section 3 and the raising mirror 15. Then, the adhesive agent 30 is infused into the groove 3a.

In this manner, the raising mirror 15 is fixed to the raising mirror fixing sections 3.

Note that, the rigid body ball 20a fit in the gap between the raising mirror 15 and the raising mirror fixing section 3 may be either the same as or different from the rigid body ball 20 fit in between the actuator base fixing section 2 and the actuator base 18. Specifically, the rigid body ball to be used may be appropriately set depending on the size, material, etc., of the fixed part.

Further, the fixed part whose position is fixed to the housing 1 in the present invention is not limited to the actuator base 18 and the raising mirror 15, and may be any part fixed to the housing 1. For example, the rigid body may be used to fix the objective lens holder 17 to the actuator base 18, and the objective lens 16 to the objective lens holder 17 in a manner as shown in the foregoing explanation. Further, the fixing method in accordance with the present invention is suitably used to fix an optical part that requires especially high positional precision (for example, the raising mirror 15) among parts fixed to the housing 1.

Further, an optical pickup in accordance with the present embodiment which includes a case and a fixed part fixed to the case may be arranged so that at least a portion of at least one side face among (A) a side face of the case that fixes the fixed part and (B) a side face of the fixed part has a slope that causes a distance between the case and the fixed part becomes narrower toward the middle of an opposed face (opposed area) of the case and the fixed part in a state where the fixed part is fixed to the case; and a rigid body ball is provided between the case and the fixed part so that the rigid body ball retains the relative positions of the case and the fixed part and presses both the side faces.

With this arrangement, the case and the fixed part contact each other via the rigid body ball, and the rigid body ball presses both the case and the fixed part. Namely, the rigid body ball presses the case and the fixed part so as to retain a constant distance between the case and the fixed part. With this, compared with the conventional arrangement in which the case and the fixed part are glued to each other using only adhesive agent, it is possible to prevent the misalignment of the position in which the fixed part is fixed to the case (relative positions between the case and the fixed part) even if the optical pickup is subject to external force, for example. Accordingly, it is possible to fix the fixed part without causing position misalignment, compared with the conventional arrangement. This can prevent the misalignment of the position of the fixed part after the optical pickup is assembled and subject to position alignment such as the alignment of the optical axes, for example. Namely, with this arrangement, it is possible to improve the product reliability of the optical pickup. Note that, “the middle of an opposed face of the case and the fixed part in a state where the fixed part is fixed to the case” refers to the middle of an opposed area on either the side face of the case or the side face of the fixed part which face each other. Namely, if the slope is formed on the case, the slope is formed substantially toward the middle of the side face of the case. On the other hand, if the slope is formed on the fixed part, the slope is formed substantially toward the middle of the side face of the fixed part.

Further, an optical pickup in accordance with the present embodiment is arranged so as to include a case; a fixed part fixed to the case, the position of the fixed part being adjusted so that a predetermined width of gap is formed between the case and the fixed part; a groove formed in at least a portion of a side face of the case which is adjacent to the fixed part, the groove having a slope which causes a distance between a bottom face of the groove and the fixed part to become narrower toward the middle of an area where the case and the fixed part face each other (opposed area); and a rigid body pressing both the groove and the fixed part.

With this arrangement, by being fit in between the sloped groove and the fixed part, the rigid body presses both the case and the fixed part. This can retain the constant relative positions of the case and the fixed part, thereby preventing the position misalignment of the fixed part. With this, it is possible to prevent the position of the fixed part from being misaligned due to ambient heat change, external shock, and the like, after the position of the fixed part is adjusted. This improves the assembling quality of the optical pickup.

Further, with this arrangement, the case and the fixed part are pressed by the rigid body. Therefore it is possible to prevent the position misalignment of the fixed part which occurs when the adhesive agent is expanded and misaligned due to changes in surrounding environment, external shock, etc., compared with the conventional instance where the fixed part is fixed to the case using only adhesive agent.

Further, because of the very simple arrangement in which the rigid body is fit in the gap, it is possible to reduce cost compared with an arrangement which uses an adjustment member such as a screw and a spring, for example, and improve the operating efficiency of the processing for assembling the parts of an optical pickup.

As described above, an optical pickup of the present invention is arranged so as to include a case; a fixed part fixed to an inside of the case; and a rigid body provided between a side face of the case and a side face of the fixed part which face each other, the rigid body pressing both the side faces and retaining relative positions of the case and the fixed part.

With this arrangement, the case and the fixed part contact each other via the rigid body, and the rigid body presses both the case and the fixed part. Namely, the rigid body presses the case and the fixed part so as to retain a constant distance between the case and the fixed part. With this, compared with the conventional arrangement in which the case and the fixed part are glued to each other using only adhesive agent, it is possible to prevent the misalignment of the position/angle in which the fixed part is fixed to the case (relative positions between the case and the fixed part) even if where the optical pickup is subject to external force, for example. Accordingly, it is possible to fix the fixed part without causing position/angular misalignment, compared with the conventional arrangement. This can prevent the misalignment of the position/angle of the fixed part after the optical pickup is assembled and subject to position alignment such as the alignment of the optical axes, for example. Namely, with this arrangement, it is possible to improve the product reliability of the optical pickup.

The optical pickup of the present invention is preferably arranged so that the fixed part is at least one of an actuator, a mirror, a prism, and a lens.

If the fixed part is an optical part such as a mirror, a prism, and a lens, or an actuator which operates the optical part, the fixed part generally requires high positional precision. In other words, because it is necessary to collect light in an accurate position on an information recording medium in order to write and read information to and from the information recording medium in high density, the positions of the optical parts, the actuator which operates the optical parts, and the like in the optical pickup need to be fixed with high precision. The foregoing arrangement can prevent the position/angular misalignment of the fixed part after the optical pickup is assembled, thereby collecting light in a more accurate position on the information recording medium. With this, it is possible to provide an optical pickup capable of writing and reading information with respect to a recording medium in higher density.

The optical pickup of the present invention is preferably arranged so that the case and the rigid body, as well as the rigid body and the fixed part, are glued together using an adhesive agent.

With this arrangement, around the rigid body is fixed using the adhesive agent, and the position of the rigid body is fixed with respect to the case and the fixed part. Specifically, the rigid body and the case, as well as the rigid body and the fixed part, are glued with each other using the adhesive agent, in a state where the rigid body presses the fixed part and the case. The rigid body and the case, as well as the rigid body and the fixed part, are not glued via the adhesive agent, but the adhesive agent is only used to prevent the rigid body from moving. With this, it is possible to further prevent the misalignment of the position of the rigid body that determines the distance between the case and the fixed part. In other words, it is possible to more firmly retain the position of the fixed part with respect to the case.

The optical pickup of the present invention is preferably arranged so that the rigid body is made of a same material that makes up the case and/or the fixed part.

With this arrangement, the rigid body is made of the same material that makes up the case and/or the fixed part. Thus, the rigid body, the case, and/or the fixed part have the same coefficient of thermal expansion. With this, it is possible to further reduce the influence of the expansion and shrinkage of the case, fixed part and/or rigid body due to thermal expansion even if the ambient temperature changes, for example. In other words, it is possible to fix the fixed part without causing the position/angular misalignment.

The optical pickup of the present invention is preferably arranged so that the rigid body has a spherical shape.

With this arrangement, by using the rigid body ball as the rigid body, it is possible to fix the case to the fixed part more easily.

The optical pickup of the present invention is preferably arranged so as to include a restricting section provided to at least one of the side face of the case and the side face of the fixed part, the restricting section preventing the rigid body from moving in, when seen from the rigid body, an extending direction of a gap between the case and the fixed part.

With this arrangement, the restricting section which prevents the rigid body from moving in the gap direction is provided. With this, it is possible to determine a position in which the rigid body is to be placed when the rigid body is fit in between the case and the fixed part.

The optical pickup of the present invention is preferably arranged so that the restricting section is a groove formed in the at least one of the side face of the case and the side face of the fixed part.

With this arrangement, the restricting section is a groove. With this, it is possible to restrict the movement of the rigid body in the gap direction, using the simple arrangement without incorporating a new member.

The optical pickup of the present invention is preferably arranged so that the rigid body has a spherical shape; and the groove extends in a depth direction, and has a slope that causes a distance between a bottom face of the groove and the case or fixed part to become narrower toward a middle of an opposed area on the side face of the case and the side face of the fixed part.

With this arrangement, the groove is sloped so that a spherical rigid body (hereinafter referred to as rigid body ball) can be fixed in an appropriate position. Further, the groove is sloped toward the middle of the opposed area. Thus, the rigid body ball fixes the case and the fixed body in the vicinity of the middle of the opposed area. With this, it is possible to fix the case and the fixed part without position/angular misalignment. Note that, the opposed area refers to an area on the side face of the case and the side face of the fixed part which face each other. Further, the depth direction refers to an inserting direction of the fixed part into the case and a direction opposite to the inserting direction.

The optical pickup of the present invention is preferably arranged so that the rigid body has a spherical shape; and the groove has a V-shaped cross-section.

With this arrangement, the groove has a V-shaped cross-section. Therefore the rigid body surely presses the V-shaped groove at two points. With this, it is possible to more surely fix the fixed part to the case without causing the rigid body to move in the gap direction, compared with the arrangement in which the rigid body presses the groove at one point, for example. Note that, the cross-section (shape) of the groove refers to a cross-section (shape) of the groove taken along a surface orthogonal to the extending direction of the groove.

An optical pickup of the present invention is arranged so as to include a case; a fixed part fixed to an inside of the case; and a rigid body provided between the case and the fixed part which face each other, the rigid body contacting a side face of the case and a side face of the fixed part, the case and the rigid body, as well as the fixed part and the rigid body, being glued together using an adhesive agent.

With this arrangement, the rigid body is provided between the case and the fixed part so that the rigid body contacts both the case and the fixed part. Further, the fixed part is fixed using the adhesive agent so as not to move. Namely, with this arrangement, the relative positions of the fixed part and the case do not change even if external force is put on the case, because the distance between the fixed part and the case is retained by the rigid body. With this, it is possible to prevent the position/angular misalignment of the fixed part more firmly, compared with the conventional arrangement in which the case is glued to the fixed part using only adhesive agent. Further, the adhesive agent in this arrangement is only used to prevent the rigid body from moving, thereby reducing the amount of the adhesive agent used, compared with the conventional arrangement. Namely, it is possible to reduce the influence of the thermal expansion and thermal shrinkage of the adhesive agent.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

1. An optical pickup, comprising:
a case;
a fixed part fixed to an inside of said case; and
a rigid body provided between a side face of said case and a side face of said fixed part which face each other, said rigid body pressing both the side faces and retaining relative positions of said case and said fixed part.

2. The optical pickup as set forth in claim 1, wherein:
said fixed part is at least one of an actuator, a mirror, a prism, and a lens.

3. The optical pickup as set forth in claim 1, wherein:
said case and said rigid body, as well as said rigid body and said fixed part, are glued together using an adhesive agent.

4. The optical pickup as set forth in claim 1, wherein:
said rigid body is made of a same material that makes up said case and/or said fixed part.

5. The optical pickup as set forth in claim 1, wherein:
said rigid body has a spherical shape.

6. The optical pickup as set forth in claim 1, further comprising:
a restricting section provided to at least one of the side face of said case and the side face of said fixed part, said restricting section preventing said rigid body from moving in, when seen from said rigid body, an extending direction of a gap between said case and said fixed part.

7. The optical pickup as set forth in claim 6, wherein:
said restricting section is a groove formed in the at least one of the side face of said case and the side face of said fixed part.

8. The optical pickup as set forth in claim 6, wherein:
said rigid body has a spherical shape; and
said groove extends in a depth direction, and has a slope that causes a distance between a bottom face of said groove and said case or fixed part to become narrower toward a middle of an opposed area on the side face of said case and the side face of said fixed part.

9. The optical pickup as set forth in claim 7, wherein:
said rigid body has a spherical shape; and
said groove has a V-shaped cross-section.

10. An optical pickup, comprising:
a case;
a fixed part fixed to an inside of said case; and
a rigid body provided between said case and said fixed part which face each other, said rigid body contacting a side face of said case and a side face of said fixed part,
said case and said rigid body, as well as said fixed part and said rigid body, being glued together using an adhesive agent.

11. The optical pickup as set forth in claim 10, wherein:
said fixed part is at least one of an actuator, a mirror, a prism, and a lens.

12. The optical pickup as set forth in claim 10, wherein:
said rigid body is made of a same material that makes up said case and/or said fixed part.

13. The optical pickup as set forth in claim 10, wherein:
said rigid body has a spherical shape.

14. A method for manufacturing an optical pickup in which a fixed part is fixed to an inside of a case, said method comprising the step of:
fitting a rigid body in between a side face of said case and a side face of said fixed part which face each other, so that said rigid body presses both the side faces and retains relative positions of said case and said fixed part.

15. A method for manufacturing an optical pickup as set forth in claim 14, further comprising the step of:
fixing together using an adhesive agent, said case and said rigid body, as well as said rigid body and said fixed body.

16. A method for manufacturing an optical pickup in which a fixed part is fixed to an inside of a case, said method comprising the steps of:
locating a rigid body between a side face of said case and a side face of said fixed part which face each other, so that said rigid body contacts both the side faces; and
fixing together using an adhesive agent, said case and said rigid body, as well as said fixed body and said rigid body, in order to prevent said rigid body from moving.
